(19) United States
(12) Patent Application Publication
(10) Pub. No.: US 2011/0164924 A1
(43) Pub. Date: Jul. 7, 2011

(54) TAMPER APPARATUS, AND TAMPER CONVERSION APPARATUS AND METHODS

(76) Inventors: Richard Bingham, Peoria, AZ (US); Russell Willis, Phoenix, AZ (US); Jeremy Willis, Glendale, AZ (US); Clint Willis, Phoenix, AZ (US)

(21) Appl. No.: 12/983,909

(22) Filed: Jan. 4, 2011

Related U.S. Application Data
(60) Provisional application No. 61/292,624, filed on Jan. 6, 2010.

(51) Int. Cl. E01C 19/32; B23P 11/00

(52) U.S. Cl. 404/133.1; 29/401.1

(57) ABSTRACT

A tamper conversion method includes providing a tamper including a ramming apparatus having a tamper foot and a gasoline-powered engine system to drive the ramming apparatus to reciprocate the tamper foot for tamping, removing the gasoline-powered engine system from the tamper exposing an engine mount, coupling a mounting plate to the engine mount, coupling an adapter plate to the mounting plate, coupling a pneumatic engine to the adapter plate operatively coupling the pneumatic engine to the ramming apparatus to drive the ramming apparatus to reciprocate the tamper foot for tamping, and coupling a conduit, formed with a pneumatic throttle, to the pneumatic engine, the conduit for applying pressurized air to the pneumatic engine to activate the pneumatic engine, and the pneumatic throttle operable for controlling the flow of pressurized air to the pneumatic engine to drive the ramming apparatus to reciprocate the tamper foot.

### FIELD OF THE INVENTION

The present invention relates generally to tampers and, more particularly, to apparatus and methods for converting gasoline-powered operation to pneumatic-powered operation.

### BACKGROUND OF THE INVENTION

A walk-behind tamper is a device used to compact or flatten soil, aggregate, or other loose material such as may be present at a construction or a landscaping site. Tampers, also known as rammers or jumping jacks, compress and increase the density of the material that is tamped to provide a stable, supportive surface. Tampers are often used on backfill material in a trench or hole in preparation for laying concrete or asphalt, or over a granular surface such as sand in preparation for laying bricks or pavers.

Conventional tampers employ gasoline-powered engines that operate to reciprocate a tamper foot for tamping purposes. Gasoline-powered engines are loud and inefficient, require an ongoing supply of gasoline, oil, spark plugs, and pull-ropes, are notoriously difficult to maintain, and require continuous and ongoing maintenance for continued operation, all of which are substantial deficiencies in the art.

### SUMMARY OF THE INVENTION

According to the principle of the invention, a tamper conversion method includes providing a tamper, the tamper including a ramming apparatus having a tamper foot, and an engine mount. The tamper further includes a gasoline-powered engine coupled to the engine mount and operatively coupled to drive the ramming apparatus to reciprocate the tamper foot for tamping, an attached fuel tank coupled to supply fuel to the gasoline-powered engine, and an attached gas throttle coupled between the fuel tank and the gasoline-powered engine to power the gasoline-powered engine, wherein the gasoline-powered engine, the fuel tank, and the gas throttle cooperate to form a gasoline-powered engine system. The method further includes removing the gasoline-powered engine system from the tamper exposing the engine mount, providing a pneumatic engine assembly including a pneumatic engine, an adapter plate, and a mounting plate, coupling the mounting plate to the engine mount, coupling the adapter plate to the mounting plate, applying the pneumatic engine to the adapter plate operatively positioning the pneumatic engine relative to the ramming apparatus, coupling the pneumatic engine to the adapter plate operatively coupling the pneumatic engine to the ramming apparatus to drive the ramming apparatus to reciprocate the tamper foot for tamping, and coupling a conduit, formed with a pneumatic throttle, to the pneumatic engine, the conduit for applying a flow of pressurized air to the pneumatic engine to activate the pneumatic engine, and the pneumatic throttle operable for controlling the flow of pressurized air to the pneumatic engine to drive the ramming apparatus to reciprocate the tamper foot. The step of coupling the mounting plate to the engine mount further includes bolting the mounting plate to the engine mount. The step of coupling the adapter plate to the mounting plate further includes bolting the adapter plate to the mounting plate at first and second aligned patterns of bolt holes formed in the adapter plate and the mounting plate, respectively. The step of coupling the pneumatic engine to the adapter plate further includes bolting the pneumatic engine to the adapter plate at third and fourth aligned patterns of bolt holes formed in the pneumatic engine and the adapter plate, respectively.

According to the principle of the invention, a tamper conversion method includes providing a tamper, the tamper including a ramming apparatus having a tamper foot, and an engine mount. The tamper further includes a gasoline-powered engine coupled to the engine mount and operatively coupled to drive the ramming apparatus to reciprocate the tamper foot for tamping, an attached fuel tank coupled to supply fuel to the gasoline-powered engine, and an attached gas throttle coupled between the fuel tank and the gasoline-powered engine to power the gasoline-powered engine, wherein the gasoline-powered engine, the fuel tank, and the gas throttle cooperate to form a gasoline-powered engine system. The method further includes removing the gasoline-powered engine system from the tamper exposing the engine mount, providing a pneumatic engine assembly including a pneumatic engine and an adapter plate, applying the adapter plate to the engine mount, applying the pneumatic engine to the adapter plate operatively positioning the pneumatic engine relative to the ramming apparatus, securing the pneumatic engine and the adapter plate to the engine mount operatively coupling the pneumatic engine to the ramming apparatus to drive the ramming apparatus to reciprocate the tamper foot for tamping, and coupling a conduit, formed with a pneumatic throttle, to the pneumatic engine, the conduit for applying a flow of pressurized air to the pneumatic engine to activate the pneumatic engine, and the pneumatic throttle operable for controlling the flow of pressurized air to the pneumatic engine to drive the ramming apparatus to reciprocate the tamper foot. The step of securing the pneumatic engine and the adapter plate to the engine mount further includes bolting the pneumatic engine and the adapter plate to the engine mount at first, second, and third, aligned patterns of bolt holes formed in the pneumatic engine and the adapter plate to the engine mount, respectively.

According to the principle of the invention, a tamper apparatus includes a tamper, the tamper including a ramming apparatus having an engine mount and a tamper foot, a pneumatic engine, a mounting plate and an adapter plate coupled between the engine mount and the pneumatic engine operatively coupling the pneumatic engine to the ramming apparatus to drive the ramming apparatus to reciprocate the tamper foot for tamping, and a conduit formed with a pneumatic throttle, the conduit for applying a flow of pressurized air to the pneumatic engine to activate the pneumatic engine to drive the ramming apparatus to reciprocate the tamper foot, the pneumatic throttle controlling the flow of pressurized air through the conduit. The mounting plate is bolted to the engine mount, the adapter plate is bolted to the mounting plate at first and second aligned patterns of bolt holes formed in the adapter plate and the mounting plate, respectively, and the pneumatic engine is bolted to the adapter plate at third and fourth aligned patterns of bolt holes formed in the pneumatic engine and the adapter plate, respectively.

### BRIEF DESCRIPTION OF THE DRAWINGS

Referring to the drawings:

FIG. 1 is an isometric view of a prior art gas tamper including a ramming apparatus having a tamper foot and an engine mount, and an attached gasoline-powered engine system including, in general, a gasoline-powered engine, a fuel tank, and a gas throttle;

FIG. 2 is a view of the embodiment of FIG. 1 illustrating the gasoline-powered engine system detached from the ramming apparatus exposing the engine mount;

FIG. 3 is an exploded isometric view of a pneumatic engine assembly shown exploded relative to the ramming apparatus of FIG. 2;

FIG. 4 is an isometric view of the pneumatic engine assembly of FIG. 3 shown assembled and installed to the ramming apparatus forming a pneumatic tamper constructed and arranged in accordance with the principle of the invention;

FIG. 5 is an exploded isometric view of portions of the pneumatic engine assembly of FIG. 3 including a pneumatic engine, an adapter plate, a clutch assembly, and a mounting plate;

FIG. 6 is an isometric view of the pneumatic engine, the adapter plate, the clutch assembly, and the mounting plate as they would appear assembled, including a muffler and a conduit applied to the pneumatic engine;

FIG. 7 is an exploded isometric view of portions of a pneumatic engine assembly including the pneumatic engine, the adapter plate, and the clutch assembly of FIG. 5;

FIG. 8 is a section view taken along line 8-8 of FIG. 4 illustrating the clutch assembly in a disengaged condition; and

FIG. 9 is a view similar to that of FIG. 8 illustrating the clutch assembly in an engaged condition.

### DETAILED DESCRIPTION

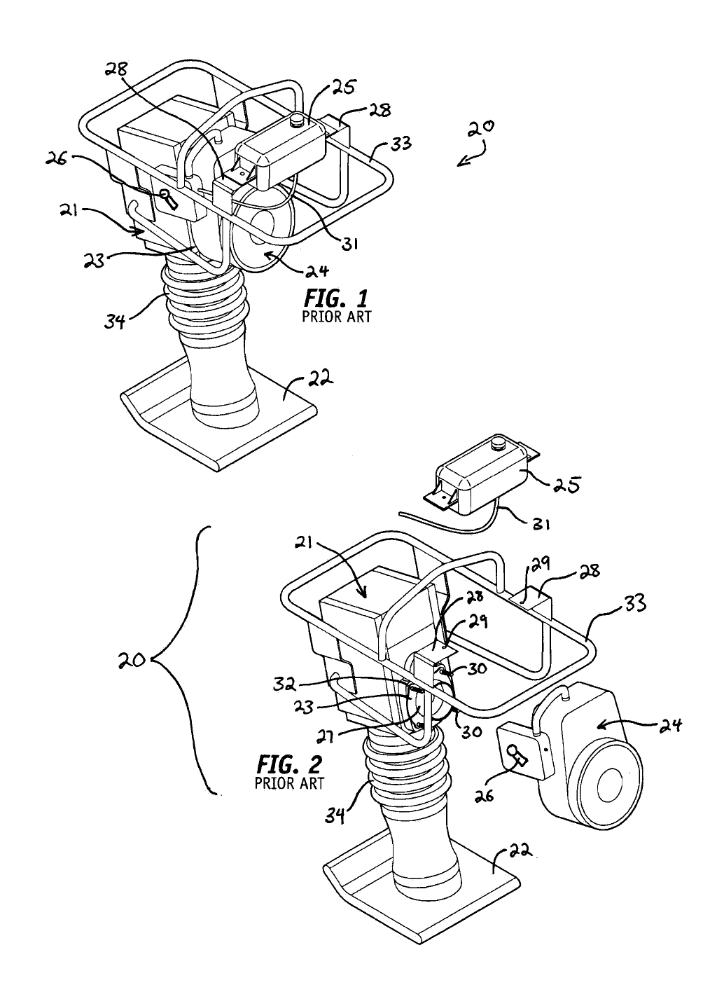

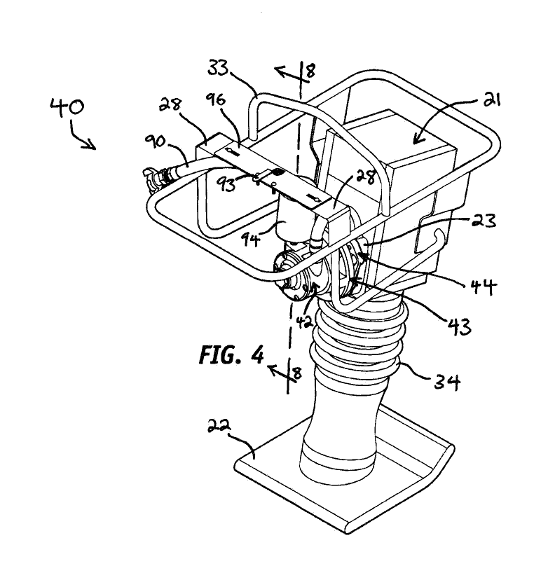

Turning now to the drawings, in which like reference characters indicate corresponding elements throughout the several views, attention is first directed to FIG. 1 which illustrates a tamper 20 as known in the prior art. Tamper 20 is a conventional walk-behind, gasoline-powered tamper and is best referred to as gas tamper 20. Gas tamper 20 and its constituent parts are constructed primarily from cast or machined metal, such as steel, aluminum, or other material having similar rigid, rugged, and strong material characteristics. Gas tamper 20 includes a ramming apparatus, denoted generally at 21, having a tamper foot 22 and an engine mount 23. Gas tamper 20 is fashioned with a gasoline-powered engine system including, in general, a gasoline-powered engine 24, a fuel tank 25, and a gas throttle 26. Gasoline-powered engine 24 may simply be referred to as gas engine 24. Gas engine 24 is coupled to engine mount 23 and is operatively coupled to drive ramming apparatus 21 to reciprocate tamper foot 22 for tamping. Ramming apparatus 21 is formed with a conventional transmission, which is coupled between gas engine 24 and tamper foot 22 passing through a rubber boot or bellows 34 above tamper foot 22 and this is a conventional and well-known arrangement. Bellows 34 prevent dust and debris from entering gas tamper 20. Gas engine 24 is coupled to engine mount 23 by bolts 30 or other releasable fasteners, as shown in FIG. 2. Fuel tank 25 is coupled to gas tamper 20 to supply fuel to gas engine 24. Fuel tank 25 is secured to end held by mounting brackets 28 attached to a handle 33 of gas tamper 20. Handle 33 is available to be taken up by hand to maneuver gas tamper 20 in the operation of gas tamper 20 in a conventional manner. Mounting brackets 28 are positioned on opposite sides of handle 33 and provide a stable platform for fuel tank 25 and include bolts holes 29 at which fuel tank 25 is secured through bolting to mounting brackets 2. Conduit 31 couples fuel tank 25 to gas engine 24 in fluid communication, allowing fuel to pass from fuel tank 25 to gas engine 24. Gas throttle 26 controls the amount or volume of fuel supplied to gas engine 24, thus powering and controlling the speed of gas engine 24 and the tamping of gas tamper 20. Gas tamper 20 is a conventional gasoline-powered tamper, which is notoriously well-known in the art. According to the principle of the invention, gas tamper 20 is converted to a pneumatic or air-powered tamper 40, as shown in FIG. 4, through the method steps described below. Tamper 40 is a an air-powered tamper, which is a form of a pneumatic tamper, and is best referred to as air tamper 40.

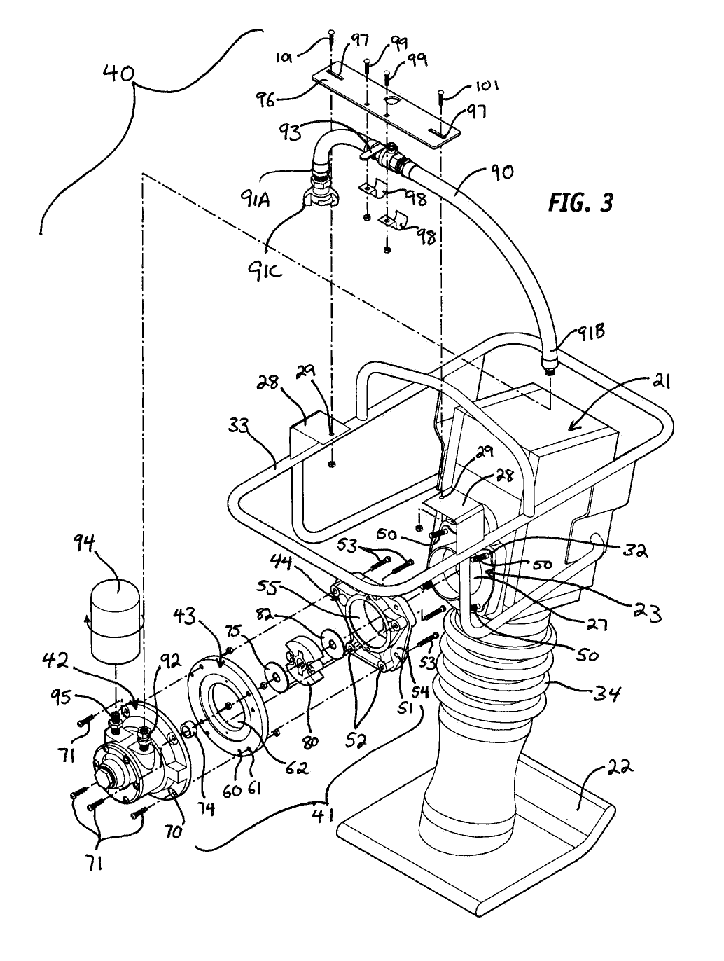

To convert gas tamper 20 to air tamper 40 shown in FIG. 3 and FIG. 4, according to the principle of the invention, the gasoline-powered engine system of gas tamper 20 is removed from ramming apparatus 21 as shown in FIG. 2. Ensuring all shut-off valves on fuel tank 25 are closed, conduit 31 is decoupled from gas engine 24. Any fuel in fuel tank 25 is drained and disposed of. Fuel tank 25 is removed from gas tamper 20 by loosening bolts or other fastening devices securing fuel tank 25 to gas tamper 20 at mounting brackets 28 formed on handle 33. Fuel tank 25 is then completely removed from gas tamper 20 as shown in FIG. 2, exposing mounting brackets 28 and bolt holes 29 formed in mounting brackets 28. Gas engine 24 is then disconnected from ramming apparatus 21. Gas engine 24 is coupled to ramming apparatus 21 at engine mount 23 with bolts 30 or other fasteners. Nuts securing gas engine 24 on bolts 30 are loosened and removed. Gas engine 24 is removed from ramming apparatus 21 as shown in FIG. 2, exposing engine mount 23 and a clutch drum 27 operatively coupled to the transmission of ramming apparatus 21 in a conventional and well-known manner. Bolts 30 are threaded in bolt holes 32 formed in engine mount 23 and encircle clutch drum 27. Bolt holes 32 are spaced-apart and arranged in a pattern in engine mount 23 encircling clutch drum 27. After the gasoline-powered engine system is detached from ramming apparatus 21, a pneumatic engine assembly is attached to ramming apparatus 21 to form air-powered air tamper, namely, a pneumatic tamper.

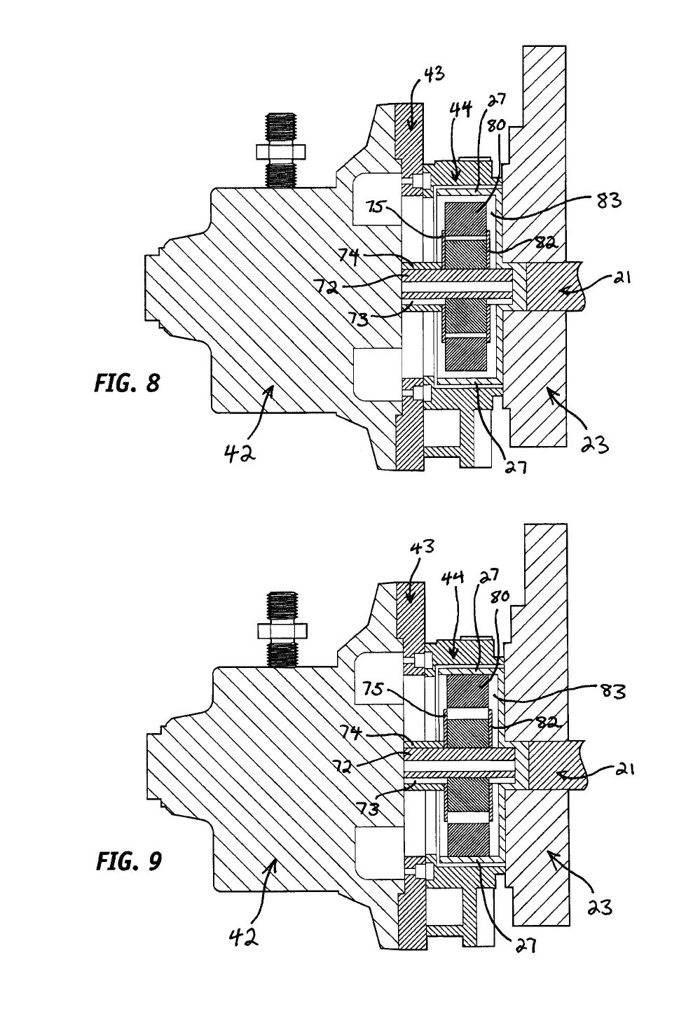

FIG. 6 illustrates a pneumatic or air engine assembly 41, which is provided and used to replace the gasoline-powered engine assembly to form air tamper 40, according to the principle of the invention. Pneumatic engine assembly 41 includes an air engine 42, formed with clutch assembly 80, an adapter plate 43 affixed to air engine 42, and a mounting plate 44 affixed to adapter plate 43. Adapter plate 43 is secured between air engine 42 and mounting plate 44, and is used to secure air engine 42 to mounting plate 44 to form an operative coupling between air engine 42 and ramming apparatus 21 to activate ramming apparatus 21 to reciprocate tamper foot 22 for tamping. Adapter plate 43 is used to couple air engine 42 to mounting plate 44 secured to engine mount 23 to provide the operative coupling between air engine 42 and ramming apparatus 21. Clutch assembly 80 is part of air engine 42. Pneumatic engine assembly 41 is coupled to engine mount 23 of ramming apparatus 21 and shown in FIGS. 8 and 9 and is operatively coupled to clutch drum 27 to rotate clutch drum 27 to drive tamper foot 22 of ramming apparatus 21 for tamping. Pneumatic engine assembly 41 is formed and applied to ramming apparatus 21 through the steps described below.

Air tamper 40 incorporates numerous conventional nut-and-bolt assemblies each including a bolt consisting of a shank or shaft having an end formed with an enlarged bolt head and an opposed externally threaded end, and an internally threaded nut that threads onto and secures the externally threaded end of the bolt. The bolts of the various nut-and-bolt assemblies are conventionally installed through openings formed in the various parts of air tamper 40 and are assembled with the corresponding threaded nuts to secure parts together as will be explained. The various nut-and-bolt assemblies and the corresponding openings that receive the bolts represent conventional arrangements, the use and application of which are well-known to the skilled artisan. As such, the various nut-and-bolt assemblies are not discussed in detail and are each given a single reference numeral for reference purposes, unless otherwise referenced, as will be clearly seen. As such, when a nut-and-bolt assembly is applied to a structural element, the bolt is received by an opening in the structural element and is secured between the bolt head and the threaded nut. Furthermore, when a nut-and-bolt assembly is applied to structural elements, the bolt is received by corresponding openings in the structural elements, which are secured between the bolt head located on one side of one of the structural elements and the threaded nut located on an opposed side of the opposed structural element. Further, the term “bolting” means to fasten with one or more bolts or one or more nut-and-bolt assemblies, or that there is a fastening between parts with one or more bolts or one or more nut-and-bolt assemblies.

In the conversion of gas tamper 20 of FIGS. 1 and 2 to air tamper 40 of FIGS. 3 and 4 mounting plate 44 is affixed to engine mount 23, and adapter plate 43 is coupled between air engine 42 and mounting plate 44 operatively coupling air engine 42 to ramming apparatus 21 to drive ramming apparatus 21 to reciprocate tamper foot 22 for tamping. Adapter plate 43 facilitates a coupling between air engine 42 and mounting plate 44 secured to engine mount 23 of ramming apparatus 21.

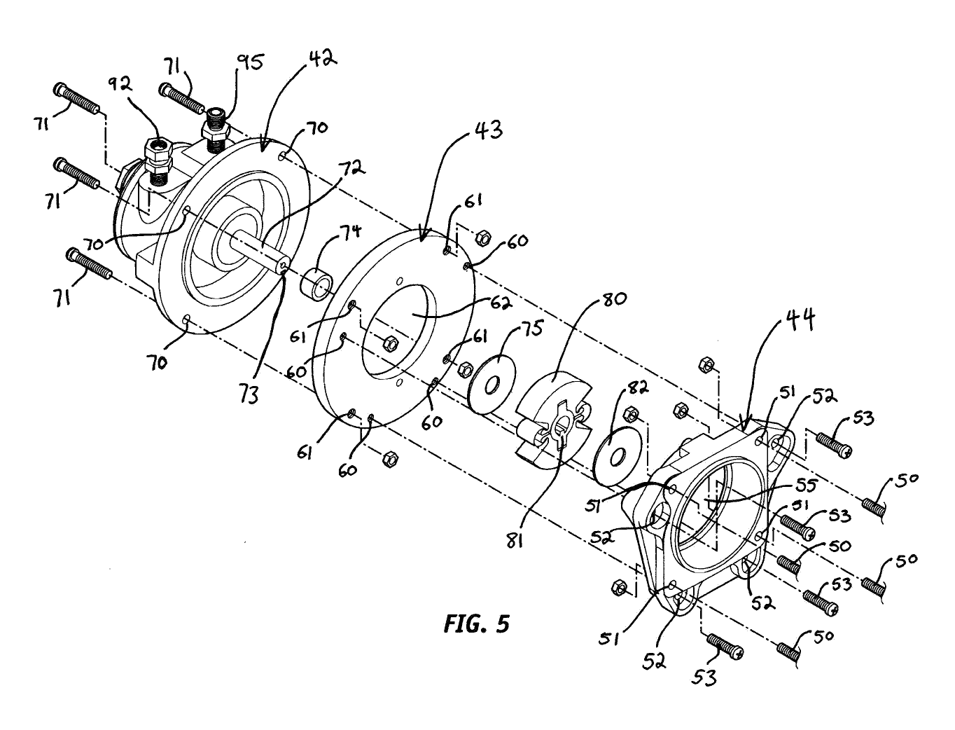

As seen in FIG. 3, bolts 50 are applied to bolt holes 32 in engine mount 23. Mounting plate 44 is applied to engine mount 23 for coupling to engine mount 23 through bolting. Referencing FIG. 3 and FIG. 5, mounting plate 44 is rigid, rugged, and strong, and is broad and stout. Mounting plate 44 is made of cast or machined metal such as steel or aluminum or other similar material. Mounting plate 44 is formed with a central, circular opening 55 that extends therethrough. Mounting plate 44 is formed with two sets of holes, including holes 51 and holes 52, which are spaced apart and which are located around opening 55. Holes 51 are arranged in a pattern around central opening 55, and holes 52 are arranged in a separate pattern around central opening 55. The pattern of holes 51 is different from the pattern of holes 52. Holes 51 are used to bolt mounting plate 44 to engine mount 23, and holes 52 are used to bolt mounting plate 44 to adapter plate 43. The patterns of holes 51 and 52 possess similar spatial relationships, and are located at different locations around mounting plate 44 encircling opening 55. In the present embodiment, there are four holes 51 arranged in a generally square pattern, and there are four holes 52 arranged in a generally square pattern that is offset with respect to the pattern of holes 51.

Hole pattern 51 relates to bolts 50 and the pattern of bolt holes 32 to which bolts 50 are applied in engine mount 23. Mounting plate 44 has a recess 54 around hole pattern 51. Mounting plate 44 is positioned proximate to engine mount 23 of ramming apparatus 21, so as to register the pattern of holes 51 with bolts 50 applied to bolt holes 32. Bolts 53 are applied to holes 52 in mounting plate 44 so that the enlarged head ends of bolts 53 are directed toward ramming apparatus 21 and the threaded ends of bolts 53 are directed away from ramming apparatus 21, opposite mounting plate 44, and into recess 54. Bolts 53 are passed through holes 52 until the enlarged head ends of bolts 53 are received in juxtaposition against mounting plate 44. Because bolts 53 are applied to holes 52, bolts 53 are arranged in the pattern of holes 52, according to the principle of the invention. With bolts 53 applied to mounting plate 44, mounting plate 44 is positioned opposite to engine mount 23, holes 51 are registered with bolts 50, clutch drum 27 is registered with central opening 55 through mounting plate 44, and mounting plate 44 is applied to engine mount 23 and bolts 50 are concurrently applied into and through holes 51 and mounting plate 44 is moved toward and against engine mount 23 is received in juxtaposition against engine mount 23 limiting further movement of mounting plate 44 toward ramming apparatus 21 and clutch drum 27 is located in and through central opening 55 of mounting plate 44. FIGS. 8 and 9 show mounting plate 44 as it would appear applied to and secured to engine mount 23 of ramming apparatus 21 and clutch drum 27 is received into and through central opening 55 of mounting plate 44. Bolts 50 are threaded with corresponding nuts at recess 54 on mounting plate 44 on the opposite side of mounting plate 44 facing adapter plate 43, forming nut-and-bolt assemblies which securely couple mounting plate 44 to engine mount 23 through bolting. After securing mounting plate 44 to engine mount 23, adapter plate 43 is coupled between mounting plate 44 and air engine 42 to operatively couple air engine 42 to ramming apparatus 21 to drive ramming apparatus 21 to reciprocate tamper foot 22 for tamping.

Referencing FIGS. 3 and 5 in relevant part, adapter plate 43 is rigid, rugged, and strong, and is broad and stout and in shape is generally that of a disk or a broad circular washer as illustrated. Adapter plate 43 is made of cast or machined metal such as steel, aluminum, or other similar material. Adapter plate 43 is circular in shape and has a central, circular opening 62 located at an intermediate position through adapter plate 43. Adapter plate 43 is formed with two sets of holes encircling opening 62, including holes 60 and holes 61. Holes 60 are spaced apart and are arranged in a pattern, and holes 61 are spaced apart and are arranged in a different, separate pattern. The pattern of holes 60 and the pattern of holes 61 possess similar spatial relationships between individual holes in the pattern, and are located at different locations on adapter plate 43. The pattern of holes 60 is generally square, and the pattern of holes 61 is also generally square.

In the present embodiment, there are four holes 60 arranged in a pattern. The number of holes 60 and the pattern of holes 60 relate to the number of holes 52 and the pattern of holes 52 and also the number and corresponding pattern of bolts 53 applied to holes 52. Adapter plate 43 is positioned proximate to mounting plate 44 opposite mounting plate 44 from ramming apparatus 21, registering and aligning holes 60 with bolts 53 applied to holes 52 in mounting plate 44, and register and aligning central opening 62 of adapter plate 43 with central opening 55 of mounting plate 44. Adapter plate 43 is applied onto bolts 53, such that the individual holes 60 receive and thread onto bolts 53, and adapter plate 43 is received in juxtaposition against mounting plate 44, limiting further movement of adapter plate 43 toward mounting plate 44. Bolts 53 thread into openings 60 and are tightened rigidly securing adapter plate 43 to mounting plate 44 bolting adapter plate 43 to mounting plate 44 in preparation for securing air engine 42.

Air engine 42 is entirely conventional and is a form of a pneumatic engine. Air engine 42 has a rotor shaft 72 formed with a keyway 73. A spacer 74 is applied to rotor shaft 72. Spacer 74 encircles rotor shaft 72, and rotates freely about and with respect to rotor shaft 72. Washers 75 and 82 are also applied to rotor shaft 72 as is a clutch assembly 80, which is positioned between washers 75 and 82. Washer 75 is applied to rotor shaft 72 and is received against spacer 74. Washer 75 encircles and rotates freely with respect to rotor shaft 72. Clutch assembly 80 is applied to rotor shaft 72 and is received against washer 75, and washer 82 is then applied onto rotor shaft 72 and is received against clutch assembly 80. Like washer 75, washer 82 encircles and rotates freely with respect to rotor shaft 72. Clutch assembly 80 is an entirely conventional centrifugal clutch or clutch assembly and is formed with a key 81 that corresponds to and registers within keyway 73 formed in rotor shaft 72. The centrifugal clutch forming clutch assembly 80 is applied to rotor shaft 72, and key 81 in clutch assembly 80 keys into keyway 73 in rotor shaft 72 to lock clutch assembly 80 to rotor shaft 72 so that clutch assembly 80 and rotor shaft 72 move together in cooperative rotation. The keyed attachment between clutch assembly 80 and rotor shaft 72 prevent clutch assembly 80 from rotating relative to rotor shaft 72. Spacer 74 positions clutch assembly 80 along rotor shaft 72 to ensure clutch assembly 80 operatively couples ramming apparatus 21 when secured to adapter plate 43, specifically, to ensure clutch assembly 80 operatively engages clutch drum 27 of ramming apparatus 21 as shown in FIGS. 8 and 9, and washers 75 and 82 likewise cooperate to position clutch assembly 80 and reduce rotational friction as clutch assembly 80 rotates with rotor shaft 72.

Referring again to FIG. 5, air engine 42 is has an outwardly projecting flange encircling rotor shaft 72, and which is formed with holes 70 arranged in a pattern. There are four holes 70 in air engine 42, which are formed in the flange of air engine 42 encircling rotor shaft 72. The number of holes 70 and the pattern of holes 70 relate to the number of holes 61 and the pattern of holes 61 formed in adapter plate 43. Air engine 42 is positioned proximate to adapter plate 43 opposite adapter plate 43 from ramming apparatus 21, registering and aligning holes 70 in air engine 42 with holes 61 formed in adapter plate 43. Air engine 42 is moved toward and against adapter plate 43 registering holes 70 with holes 61, and applying clutch assembly 80 in clutch drum 27 as shown in FIGS. 8 and 9 operatively positioning clutch assembly 80 with respect to clutch drum 27. Referring back to FIGS. 3 and 5 in relevant part, bolts 71 are concurrently passed through holes 70 formed in air engine 42 and through holes 61 formed in adapter plate 43. Nuts are threaded onto bolts 71 at recess 54 of mounting plate 44, forming nut-and-bolt assemblies which securely couple air engine 42 to adapter plate 43 through bolting thereby operatively coupling air engine 42 to ramming apparatus 21. And so mounting plate 44 and adapter plate 43 are positioned between ramming apparatus 21 and air engine 42, mounting plate 44 is bolted to ramming apparatus 21 at engine mount 23 and to adapter plate 43, and air engine 42 is, in turn, bolted to adapter plate 43 to operatively couple air engine 42 to ramming apparatus 21.

With air engine 42 coupled to adapter plate 43, adapter plate 43 coupled to mounting plate 44, and mounting plate 44 coupled to engine mount 23 of ramming apparatus 21, air engine 42 is operatively positioned and coupled relative to ramming apparatus 21. Mounting plate 44, adapter plate 43, and spacer 74 applied to rotor shaft 72 position clutch assembly 80 within a receiving space 83 of clutch drum 27, as shown in FIG. 8, and this is an operative positioning of clutch assembly 80 with respect to clutch drum 27 that forms of an operative coupling of air engine 42 to ramming apparatus 21. Rotor shaft 72 extends into and through central opening 62 of adapter plate 62 and into central opening 55 of mounting plate 44, clutch drum 27 extends through opening 55 in mounting plate 44, and clutch assembly 80 positioned on rotor shaft 72 locating clutch assembly 80 in receiving space 83 of clutch drum 27.

In the operation of air engine 42, rotor shaft 72 and clutch assembly 80 rotate axially within receiving space 83. Clutch assembly 80 conventionally moves between a first retracted condition and a second expanded condition in response to this rotation. In the first condition of clutch assembly 80, at no rotation or at a low rotational speed, clutch assembly 80 is in a retracted state and does not engage clutch drum 27, as shown in FIG. 8. In the second condition of clutch assembly 80, at sufficiently high rotational speed, clutch assembly 80 expands radially outward from rotor shaft 72 toward clutch drum 27 to assume an expanded state engaging and coupling clutch drum 27, as shown in FIG. 9. In this second condition, rotor shaft 72 rotates, clutch assembly 80 rotates, and clutch drum 27 rotates due to the coupling between clutch assembly 80 and clutch drum 27. Rotating clutch assembly 80 coupled to clutch drum 27 imparts rotation to clutch drum 27 through a frictional engagement therebetween to thus drive ramming apparatus 21 to reciprocate tamper foot 22 for tamping.

Air engine 42 operates through the input of pressurized air from a source of pressurized air (not shown). Looking to FIG. 3 there is shown a conduit 90, having opposed upstream and downstream ends 91A and 91B, which is used to couple air engine 42 to a source of pressurized air (not shown) to connect air engine 42 in gaseous communication with a source of a pressurized air to conventionally power and activate air engine 42. The source is pressurized air is preferably an air compressor. Downstream end 91B of conduit 90 is coupled to an inlet 92 on air engine 42, and upstream end 91A is formed with a coupling 91C, which is a crowsfoot coupling in the present embodiment, used to couple conduit 90 to the source of pressurized air, namely, the air compressor. Conduit 90 is formed with a conventional pneumatic throttle 93 between upstream and downstream ends 91A and 91B, and is used to modulate the flow of pressurized air through conduit 90 to air engine 42 to control the power of air engine 42. An intermediate portion of conduit 90 between upstream and downstream ends 91A and 91B is coupled to air tamper proximate to handle 33. Conduit 90 and pneumatic throttle 93 are preferably mounted to a throttle plate 96 coupled to handle 33. Throttle plate 96 is sized appropriately to be received on and between mounting brackets 28. Throttle plate 96 is formed with two opposed elongate slots 97 which correspond to bolt holes 29 formed in each of mounting brackets 28. Conduit brackets 98 secure conduit 90 to the underside of throttle plate 96. Conduit brackets 98 are bolted with nut-and-bolt assemblies 99 to the underside of throttle plate 96 securing conduit 90 between conduit brackets 98 and the underside of throttle plate 96. Conduit brackets 98 are channeled to receive conduit 90 on either side of pneumatic throttle 93 and secure conduit 90 against throttle plate 96. Throttle plate 96 is bolted to mounting brackets with nut-and-bolt assemblies 101, and pneumatic throttle 93 is applied through an opening in throttle plate 96 and extends upwardly from the upper side of throttle plate 96 so as to be easily taken up by hand for operation. By operating pneumatic throttle 93, an operator of air tamper can control the flow of pressurized air to air engine 42 to drive ramming apparatus 21 to reciprocate tamper foot 22 for tamping. Air engine 42 is formed with a conventional attached muffler 94 as shown in FIG. 4. Muffler 94 is coupled to an outlet 95 of air engine 42, and muffles the sound of air engine 42 during operation.

In sum, the method of converting gasoline-powered gas tamper 20 to air-powered or pneumatic air tamper includes removing the gasoline-powered engine system from gas tamper 20 exposing engine mount 23, providing a pneumatic engine assembly including air engine 42, adapter plate 43, and mounting plate 44, coupling mounting plate 44 to engine mount 23, coupling adapter plate 43 to mounting plate 44, coupling air engine 42 to adapter plate 43 operatively coupling air engine 42 to ramming apparatus 21 to drive ramming apparatus 21 to reciprocate tamper foot 22 for tamping, and coupling conduit 90, formed with pneumatic throttle 93, to air engine 42, wherein conduit 90 is for applying a flow of pressurized air to air engine 42 to activate air engine 42, and pneumatic throttle 93 is operable for controlling the flow of pressurized air to air engine 42 to drive ramming apparatus 21 to reciprocate tamper foot 22. The described conversion of gasoline-powered gas tamper 20 to air-powered or pneumatic air tamper is simple and easy to carry out, and the formed air-powered or pneumatic air tamper is operationally considerably reliable, long-lasting, efficient, quiet, energy efficient, and is resistant to breakage and failure.

In a particular embodiment, air engine 42, adapter plate 43, and mounting plate 44 are aligned with engine mount 23 so that hole patterns in each of air engine 42, adapter plate 43, mounting plate 44, and engine mount 23 register with and are common to each other. With the various patterns of holes in the respective air engine 42 and adapter plate 43 and engine mount 44 so aligned, continuous bolts extend from bolt holes 32 of engine mount 23, through one of hole patterns 51 and 52 of mounting plate 44, through one of hole patterns 60 and 61 of adapter plate 43, and through hole pattern 70 of air engine 42, allowing a single set of bolts to securely couple air engine 42, adapter plate 43, and mounting plate 44 to engine mount 23.

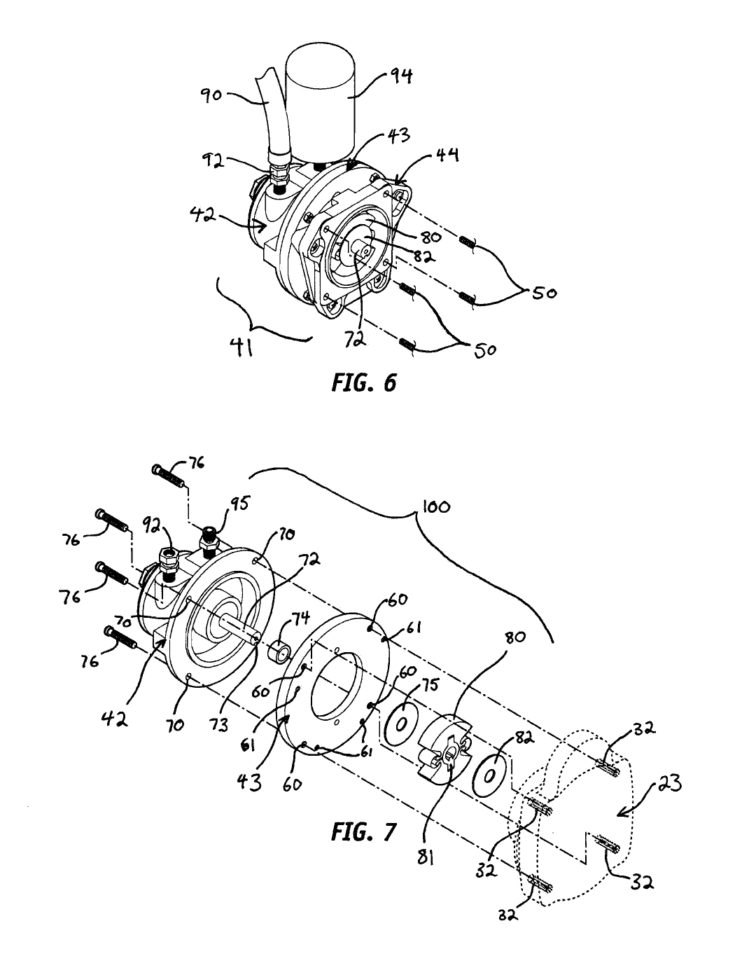

In yet a further embodiment, the pneumatic engine assembly may be used without mounting plate 44 in the installation to a ramming apparatus of a tamper to form a pneumatic tamper. To illustrate this attention is now directed to FIG. 7, in which, according to the principle of the invention, a pneumatic engine assembly 100 is shown which includes air engine 42 and adapter plate 43 and clutch assembly 80 as described above, without the provision of mounting plate 42. Pneumatic engine assembly 100 is shown, in exploded view, as it would be secured to engine mount 23 (shown in phantom outline) of ramming apparatus 21 with bolts 76. Pneumatic engine assembly 100 is coupled to ramming apparatus 21 to form an air tamper in same way that pneumatic engine assembly 41 is coupled to ramming apparatus 21 to form air tamper.

Ramming apparatus 21 is readied for coupling with pneumatic engine assembly 100 in the same manner that ramming apparatus 21 is readied for coupling with pneumatic engine assembly 41 as discussed above. That discussion bears repeating here. Fuel tank 25 and gasoline-powered gas engine 24 are removed from gasoline-powered gas tamper 20 of FIG. 2, exposing engine mount 23, clutch drum 27, and bolts 30 in bolt holes 32, as well as mounting brackets 28 and bolt holes 29 in mounting brackets 28. Bolts 30 are removed from bolt holes 32 exposing the pattern of bolt holes 32.

Returning to FIG. 7, adapter plate 43 is formed with two sets of holes namely, holes 60 and holes 61. Air engine 42 and adapter plate 43 are aligned with engine mount 23 so that patterns of holes in each of air engine 42, adapter plate 43, and engine mount 23 align with each other. Holes 70 formed in air engine 42 are aligned with holes 32 formed in engine mount 23 and with holes 60 of adapter plate 43 or, in the alternative, holes 61 of adapter plate 43. Bolts 76 are applied to the aligned holes of air engine 42, adapter plate 43 and engine mount 23. Bolts 76 thread into openings 32 and are tightened to bolt air engine 42 and adapter plate 43 to engine mount 23 forming air tamper. With the patterns of hole in air engine 42, adapter plate 43, and engine mount 23 aligned, bolts 76 are received by hole pattern 70 formed in air engine 42 and one of hole patterns 60 and 61 formed in adapter plate 43 and received and secured by bolt holes 32 of engine mount 23, securely coupling air engine 42 and adapter plate 43 to engine mount 23 through bolting operatively coupling air engine 42 to ramming apparatus 21 as described above.

And so in an alternate embodiment of the invention in connection with the embodiment of FIG. 7, the method of converting gasoline-powered gas tamper 20 to air-powered or pneumatic air tamper includes removing the gasoline-powered engine system from gas tamper 20 exposing engine mount 23, providing a pneumatic engine assembly including air engine 42 and adapter plate 43, applying adapter plate 43 to engine mount 23, securing air engine 42 and adapter plate 43 to engine mount 23 operatively coupling air engine 42 to ramming apparatus 21 to drive ramming apparatus 21 to reciprocate tamper foot 22 for tamping, and coupling conduit 90, formed with pneumatic throttle 93, to air engine 42, whereby conduit 90 is for applying a flow of pressurized air to air engine 42 to activate air engine 42, and pneumatic throttle 93 is operable for controlling the flow of pressurized air to air engine 42 to drive ramming apparatus 21 to reciprocate tamper foot 22.

Exemplary methods of converting a gas tamper to an air tamper are disclosed. The pneumatic engine assembly, whether engine assembly 41 or engine assembly 100, including conduit 90, muffler 94, throttle plate 96 and conduit brackets 98, and associated bolts and nut-and-bolt assemblies together form a tamper conversion apparatus, assembly, or kit useful in converting a gas tamper to an air tamper as herein specifically described. A conversion kit constructed and arranged in accordance with the principle of the invention is useful in replacing the conventional gasoline powered engine assembly of a conventional gas tamper to form an air tamper that is a “green” product requiring no fossil fuel to operate eliminating the need to use gasoline and oil, and eliminating environmentally harmful exhaust fumes. Eliminating these fluids also cuts maintenance costs because there is no longer gasoline or oil to contend with or dispose of, and no more gas-engine related problems. Also, an air tamper constructed in accordance with the principle of the invention is safe as there are no exhaust fumes to harm the operator and no heat sources around flammable lines or other materials. Moreover, an air tamper constructed and arranged in accordance with the principle of the invention is light and easy to use, and operationally efficient.

The present invention is described above with reference to preferred embodiments. However, those skilled in the art will recognize that changes and modifications may be made in the described embodiments without departing from the nature and scope of the present invention. Various further changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A method, comprising:
providing a tamper, the tamper including a ramming apparatus having a tamper foot, an engine mount, a gasoline-powered engine coupled to the engine mount and operatively coupled to drive the ramming apparatus to reciprocate the tamper foot for tamping, an attached fuel tank coupled to supply fuel to the gasoline-powered engine, and an attached gas throttle coupled between the fuel tank and the gasoline-powered engine to power the gasoline-powered engine, wherein the gasoline-powered engine, the fuel tank, and the gas throttle cooperate to form a gasoline-powered engine system;
removing the gasoline-powered engine system from the tamper exposing the engine mount;
providing a pneumatic engine assembly including a pneumatic engine, an adapter plate, and a mounting plate;
coupling the mounting plate to the engine mount;
coupling the adapter plate to the mounting plate;
coupling the pneumatic engine to the adapter plate operatively coupling the pneumatic engine to the ramming apparatus to drive the ramming apparatus to reciprocate the tamper foot for tamping; and
coupling a conduit, formed with a pneumatic throttle, to the pneumatic engine, the conduit for applying a flow of pressurized air to the pneumatic engine to activate the pneumatic engine, and the pneumatic throttle operable for controlling the flow of pressurized air to the pneumatic engine to drive the ramming apparatus to reciprocate the tamper foot.

2. The method according to claim 1, wherein the step of coupling the mounting plate to the engine mount further comprises bolting the mounting plate to the engine mount.

3. The method according to claim 2, wherein the step of coupling the adapter plate to the mounting plate further comprises bolting the adapter plate to the mounting plate at first and second aligned patterns of bolt holes formed in the adapter plate and the mounting plate, respectively.

4. The method according to claim 3, wherein the step of coupling the pneumatic engine to the adapter plate further comprises bolting the pneumatic engine to the adapter plate at third and fourth aligned patterns of bolt holes formed in the pneumatic engine and the adapter plate, respectively.

5. A method, comprising:
providing a tamper, the tamper including a ramming apparatus having a tamper foot, an engine mount, a gasoline-powered engine coupled to the engine mount and operatively coupled to drive the ramming apparatus to reciprocate the tamper foot for tamping, an attached fuel tank coupled to supply fuel to the gasoline-powered engine, and an attached gas throttle coupled between the fuel tank and the gasoline-powered engine to power the gasoline-powered engine, wherein the gasoline-powered engine, the fuel tank, and the gas throttle cooperate to form a gasoline-powered engine system;
removing the gasoline-powered engine system from the tamper exposing the engine mount;
providing a pneumatic engine assembly including a pneumatic engine and an adapter plate;
applying the adapter plate to the engine mount;
securing the pneumatic engine and the adapter plate to the engine mount operatively coupling the pneumatic engine to the ramming apparatus to drive the ramming apparatus to reciprocate the tamper foot for tamping; and
coupling a conduit, formed with a pneumatic throttle, to the pneumatic engine, the conduit for applying a flow of pressurized air to the pneumatic engine to activate the pneumatic engine, and the pneumatic throttle operable for controlling the flow of pressurized air to the pneumatic engine to drive the ramming apparatus to reciprocate the tamper foot.

6. The method according to claim 5, wherein the step of securing the pneumatic engine and the adapter plate to the engine mount further comprises bolting the pneumatic engine and the adapter plate to the engine mount at first, second, and third aligned patterns of bolt holes formed in the pneumatic engine and the adapter plate to the engine mount, respectively.

7. Tamper apparatus, comprising:
a tamper, the tamper including a ramming apparatus having an engine mount and a tamper foot;
a pneumatic engine;
a mounting plate and an adapter plate coupled between the engine mount and the pneumatic engine operatively coupling the pneumatic engine to the ramming apparatus to drive the ramming apparatus to reciprocate the tamper foot for tamping;
a conduit, formed with a pneumatic throttle, coupled to the pneumatic engine, the conduit for applying a flow of pressurized air to the pneumatic engine to activate the pneumatic engine to drive the ramming apparatus to reciprocate the tamper foot, the pneumatic throttle controlling the flow of pressurized air through the conduit.

8. The tamper apparatus according to claim 7, further comprising the mounting plate is bolted to the engine mount.

9. The tamper apparatus according to claim 8, further comprising the adapter plate is bolted to the mounting plate at first and second aligned patterns of bolt holes formed in the adapter plate and the mounting plate, respectively.

10. The tamper apparatus according to claim 9, wherein pneumatic engine is bolted to the adapter plate at third and fourth aligned patterns of bolt holes formed in the pneumatic engine and the adapter plate, respectively.
